(19) United States
(12) Patent Application Publication
(10) Pub. No.: US 2004/0171425 A1
(43) Pub. Date: Sep. 2, 2004

(54) Pre-existing knowledge and internet-based research game show

(76) Inventors: Jack Misraje, Santa Monica, CA (US); Alex Dickman, Woodland Hills, CA (US)

Correspondence Address: BRADLEY M GANZ, PC, P O BOX 10105, PORTLAND, OR, 97296

(21) Appl. No.: 10/376,691

(22) Filed: Feb. 28, 2003

(51) Int. Cl. A63F 13/00

(52) U.S. Cl. 463/42

(57) ABSTRACT

The present invention provides a game that integrates the use of the Internet in a very unique way. There are two distinct components of the game. The first component is a daily thirty-minute television show, viewed by a home television audience. In the television show, the contestants are tested and rewarded not only for having pre-existing knowledge of facts but also for their research skills using the Internet to find answers to questions and to complete designated projects. The second component is a Web site that replicates the television show so that at-home computer users can compete for prizes and a chance to be on a future television show.

### FIELD OF THE INVENTION

This invention relates to televised game shows and, in particular, to a televised game show in which contestants compete for money and prizes by performing research projects using the Internet, answering questions in subject categories from their personal knowledge, and finding answers to questions in subject categories by using the Internet when they do not have personal knowledge of the answers to the questions.

### BACKGROUND OF THE INVENTION

Television game shows have been popular for many years and have included a variety of formats in which contestants typically compete in front of a live studio audience for money and prizes. Some particular game shows have attracted a large television viewing audience and have remained popular over the years. Other game shows have been popular at first due to a novel format or current trend but have not been able to maintain a television viewing audience as television viewers grew tired of the format or the trend upon which the game show was based. Still other game shows have never been successful at attracting a large and steady television audience.

Since television game shows remain a popular form of entertainment the television networks have tried to come up with different game formats in order to attract and keep viewers. One aspect of the most popular game shows is one in which television viewers can participate or play along with the contestants. For example, one very popular game show format is a question-and-answer format where contestants choose a subject category and answer questions based on the subject category. At-home television viewers can try to answer the questions before or along with the contestants. However, this type of participation is passive. Some attempts have been made to create interactive game show formats in which the television viewing audience can actively participate. For example, some formats require viewers to mail in information such as, for example, answers to questions or the viewer's name, address, and telephone number which information may then be randomly selected for prizes or awards. Other formats may require viewer to participate by telephone. These formats have not generally proved to be popular.

The use of the Internet has grown over the years as a way to access information. Generally, a user may access the Internet by using a personal computer (PC) that is typically connected to a telephone line. The PC generally includes browser software to access information from a provider computer commonly referred to as Web server. The location of a Web server is designated by a Uniform Resource Locator (URL) which is a string expression that represents a location identifier of a Web server. Web servers transmit the information requested by browser software of the user's PC. This information is displayed on the user's PC in the form of a Web page which may display a variety of text and graphic material. If the user knows the URL for the information desired the user simply enters the URL on the PC and using the browser software obtain the desired information.

One challenge with using the Internet is that the user often does not know the URL for a specific location of the desired information. In this instance, the user typically uses a search engine to locate the desired information. Search engines allow users to locate Web sites that have the desired information. Typing in well-constructed search queries will not necessarily reveal the desired information. There is an art form to locating desired information. Users can choose from a multitude of search engines, depending upon the sought after information. Search engines such as Dogpile, Google, or Alta Vista will return different answers to the same search queries. Moreover, finding a Web site that seems to match the search criteria might be just the first step in the search. The Web site might direct the user to other sites, which the user must decide are relevant to the search. The more obscure the search topic, the more skill the user must have to find the desired information.

There are known some games that incorporate the use of the Internet. For example, U.S. Pat. No. 6,074,299 discloses a method and system of evaluating Web search capability and tracking sequential progress of Web searches. Participants are provided clues to specific target Web sites. Once the Web site is found the user submits a form to verify that the correct Web site has been located. The user is then given another clue for another Web site. This continues until the user has found all of the target Web sites. The search is timed and the participant who has located the most target locations in the least amount of time wins. This contest is mainly one in which participants compete at home to improve their Web search capabilities in a measurable way and against other users.

Other Internet-related games include those shown and described in U.S. Pat. No. 6,106,399 which describes a role-playing game and U.S. Pat. No. 6,267,672 which describes a product sales enhancing Internet game.

### SUMMARY OF THE INVENTION

The present invention provides a game that integrates the use of the Internet in a very unique way. There are two distinct components of the game. The first component is a daily television show, viewed by a home television audience. In the television show, the contestants are tested and rewarded not only for having pre-existing knowledge of facts but also for their research skills using the Internet to find answers to questions and to complete designated projects. The second component is a Web site that replicates the television show so that at-home computer users can compete for prizes and a chance to be on a future television show.

The television show component includes three parts in which three teams of two compete against each other using their pre-existing knowledge of facts and utilizing their research skills using the Internet to find answers to questions. Part one of the television show not only acts as the first competition among the teams but also serves to introduce the contestants. In part one, the teams compete in a timed research project and are interviewed before and after the research project on many topics, such as, for example, their use of the Internet, their likes and dislikes about the Information Superhighway, their feelings about the research project, their family, jobs, education, and other aspects of their life.

The second part of the television show comprises a two-part rapid question-and-answer section. This second part of the television show includes two sessions. In each session, members of each team have different tasks. In the first session, one member of each team acts as a primary player attempting to answer questions. The other member of each team acts as research player. In the second session, the team members reverse roles.

In a third part of the television show, the team that has accumulated the most points or money from the first two parts participates in a bonus round for prizes. This round is structured like a treasure hunt. The bonus round contestants search for items on the Internet such as pictures of people or objects, URLs, quotes, addresses of famous places, etc.

In addition to the television show, a Web site is provided that replicates the television show so that at-home computer users can compete for prizes and a chance to be on a future television show. The Web site follows the same basic outline of the television show, but its purposes are a bit different. The Web site is designed to select players for future television shows, and to provide a “sticky” place where sponsors can advertise their goods and services to users who are playing for prizes.

The present invention provides a unique televised game show that incorporates the use of the Internet to present a challenging, exciting, and dramatic competition not only for the participants but also for a studio audience and at-home television viewers. Since information found on the Internet is primarily beyond the control of the game show producers the results of the competition can be amusing, entertaining, and wildly unpredictable. Unlike any existing television game show format, contestants that might not know the answer to a question from memory still have the opportunity to win the competition by utilizing their skills in using the Internet to answer questions or complete research projects.

The present invention further provides a Web site that creates an opportunity for at-home viewers to actively participate in a game that simulates the television show. The Web site offers participants an exciting and challenging competition in which they have the opportunity to be selected as a future participant on the television game show as well as the opportunity to win prizes. The Web site additionally provides sponsors of the television game show with advertising opportunities.

These and other embodiments are described in more detail in the following detailed descriptions and the figures.

### BRIEF DESCRIPTION OF THE DRAWINGS

FIG. 1 is a schematic illustration for the televised game show showing the network connection for contestants participating in a first part of the game show.

FIG. 2 is a schematic illustration of the network connection for the televised contestants participating in a second part of the televised game show.

FIG. 3 is a schematic illustration of the network connection for the televised contestants participating in a third part of the televised game show.

FIG. 4 is a flow diagram of a process of the televised game show using the network connections shown in FIGS. 1-3.

FIG. 5 is a schematic illustration for the Web site game showing the network connection for participating contestants.

FIG. 6 is a flow diagram of a process of the Web site game using the network connection shown in FIG. 5.

### DETAILED DESCRIPTION

The game of the present invention provides a unique format wherein contestants compete against each other by using their computer skills, Internet skills, and personal knowledge to win money and/or prizes. Two aspects of the game are provided wherein a first aspect includes a televised game show where plural contestants compete against each other for money and/or prizes and a second aspect includes a Web site which at-home participants can log onto in order to compete against other at-home participants for money, prizes, and/or a chance to appear on a future televised game show.

In the televised game show, contestants compete for prizes and/or money. In the preferred embodiment, the contestants compete in three separate phases with each phase having a different format. For example, Phase I of the game show comprises a timed project in which the contestants either answer questions or complete a specific task, Phase II of the game show comprises a two-part question and answer session, and Phase III of the game show comprises a bonus round.

Three teams compete in the game show with each team having two players. For example, Team 1 consists of Player 1 and Player 2. Likewise, Team 2 and Team 3 each consist of Player 1 and Player 2.

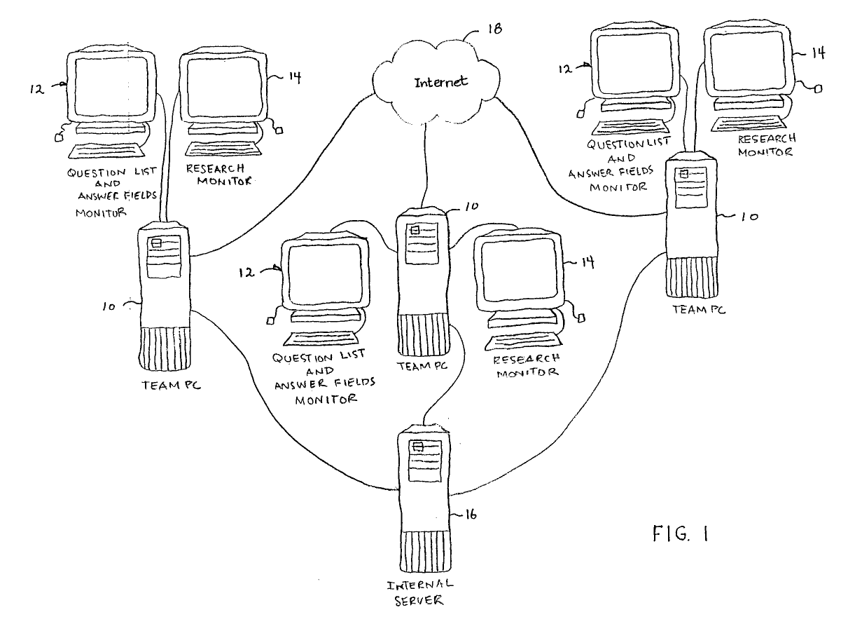

In Phase I of the game show all players from Teams 1, 2, and 3 participate in a timed project in which the players are required to answer specific questions. Contestants may answer questions using their pre-existing knowledge or, if they do not know the answer, by conducting research on the Internet. As seen in FIG. 1, each team is provided with computer equipment having Internet access. Each team is provided with a Team PC 10, a Question List and Answer Field monitor, keyboard, and mouse 12, and a Research monitor, keyboard, and mouse 14. Each Team PC 10 is connected to an internal server 16 and to the Internet 18. One member of each team is assigned to one of monitors 12 and 14. For example, Player 1 from each team may be assigned to Question List and Answer Field monitor 12 and Player 2 from each team may be assigned to Research monitor 14. It should be noted that FIG. 1 is just one example of a computer network and this invention is not limited to the specific network shown in FIG. 1. Questions appear on each team's monitor 12. For example, questions may be directed to a variety of subjects and the answers may include quotes, names, dates, or general answers. Monitor 12 includes an answer field for typing the answer to the questions. Both team members from each team attempt to answer questions that appear on Question List and Answer Field monitor 12 using their pre-existing knowledge. If the contestants know answers to the questions the answers are entered in Answer Field on monitor 12. If the answer is not known the team members of each team may research together using Research monitor 14 to access Internet 18. The contestants must answer questions within a time frame such as, for example, twenty minutes. Members of each team may confer with each other about questions or during the Internet research. One member of each team member will be responsible for managing monitor 12 for reading the question, entering the answers to questions in the Answer Field, and keeping track of time, and the other team member will be responsible for managing monitor 14 for conducting research.

All teams will have the same research questions. Each question will have a different point value determined by the difficulty of the question. As soon as one team correctly enters the answer to a question the specific question disappears from monitor 12 of all teams and that specific question is then no longer available to the other teams.

Phase I of the game show not only serves as a first competition among the teams but also serves as a way to introduce the contestants to the studio and television viewing audience. Before and after the timed project the contestants are interviewed by a game show host on many topics including their use of the Internet, their likes and dislikes about the Information Superhighway, their feelings about the research project, and personal questions regarding, for example, their family, job, and education. The interviews and the timed research competition are conducted and filmed prior to broadcast. The film is edited and then broadcast as Phase I of the game show for at-home television viewers. The contestants are introduced in Phase I and they demonstrate their thought process as they search for the answers questions or complete the assigned tasks. Money and prizes are awarded to the teams based on their correct answers and the speed in which they complete the research task.

Phase II of the game show consists of a two-part question and answer session in which members from each team are designated as either a primary player or a research player. For example, Player 1 from Team 1 may be designated as the primary player for Team 1 and Player 2 may be designated as the research player for Team 1. Members of Teams 2 and 3 would likewise be designated as the primary and research players for their associated team. In the first session of Phase II, the primary players are separated from the research players. For example, the research players are moved to an isolation booth 20 where they can neither hear questions read to the primary players nor see the primary players.

In one embodiment, each primary player is given access to a buzzer or other indicating device which the primary players activate when they want to attempt to answer a question. A selected primary player selects a dollar value for the questions and also chooses a question category. The question is then read aloud by the game show host and may also appear on a large monitor. The first primary player to activate their device is given the chance to answer the question. If the primary player does not provide the correct answer the other primary players are given the chance to answer the question by being first to activate their indicating device. If none of the primary players provides a correct answer the question is passed to the research players as discussed below.

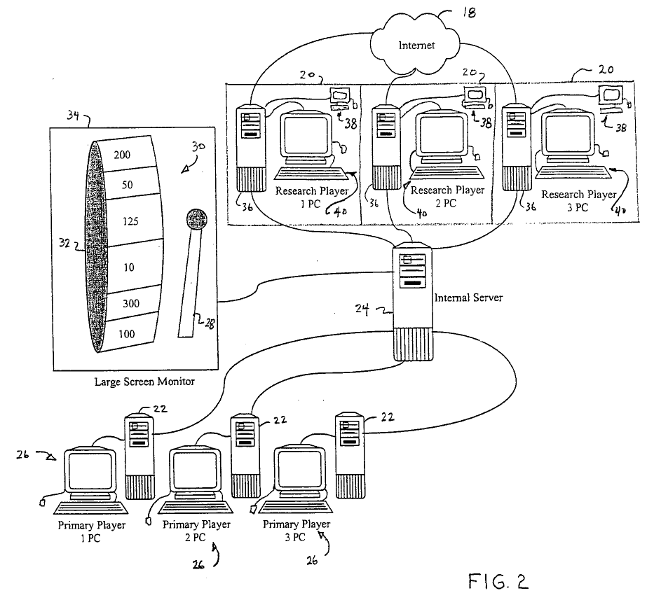

In another embodiment, each primary player is provided with a Primary Player PC 22 connected to a central server 24 as seen in FIG. 2. The Primary Player PC 22 includes a monitor, keyboard, and mouse 26. The primary player from the team with the most money from Phase I is selected as the lead player to pull a large handle 28 of a large digital slot machine 30 that has one spinning wheel 32. Wheel 32 includes various dollar or point values for questions. Various subject categories are listed on a large monitor 34 adjacent to digital slot machine 30. There are a fixed number of questions in each subject category and the questions become increasingly difficult.

The lead primary player chooses a question category. The questions have the dollar or point value established by the wheel and that value remains for all questions as long as the lead primary player is in control. Each primary player tries to answer the question using the monitor, keyboard, and mouse 26 by entering the answer into PC 22 within a specified time. The first primary player to answer correctly is awarded the dollar or point value for his or her team and gains control of selecting subject categories. Each time a different primary player gains control he or she pulls handle 28 of slot machine 30 to determine a new dollar or point value. The dollar or point value remains the same until the primary player loses control of selecting questions. A primary player loses control if another primary player first answers correctly. If all primary players fail to answer the question correctly within the specified time limit the television host announces the correct answer to the audience.

When all primary players fail to answer the question it passes to the research players located in isolation booths 20. The research players have not heard or seen either the questions or answers and are not able to see the primary players in action. The research players are provided with a PC 36 connected to a display monitor, keyboard, and mouse 38 to display questions passed from the primary players and for the players to enter and display answers to questions and a research monitor, keyboard, and mouse 40 to conduct research using the Internet. Personal computers (PC's) 36 are connected to central server 24 so that the questions that were passed from the primary players are displayed on monitors 38. Research monitors 40 are connected to the Internet 18. Display monitors 38 include an answer field that a research player can enter an answer to the question using his or her pre-existing knowledge. If the research player does not know the answer to the question he or she can use research monitor 40 to conduct research on the Internet 18. As soon as one of the research players answers the question correctly, that question is no longer available and is removed from the other research player's monitors. The research player that answers correctly will get the full dollar or point value awarded to his or her team. When the first session of Phase II is completed the primary players and research players switch positions and a second session is conducted. The first session ends when all of the questions have been answered or when a specified amount of time has run out.

Additionally, the contestants have an opportunity to win a “surprise prize” during Phases I and II. One of the questions throughout Phases I and II will be randomly designated as a “surprise prize question.” The designation is represented by an icon next to the written question. The team (from Phase I) or primary player (from Phase II) that first correctly answers the “surprise prize question” wins the “surprise prize” for his or her team. If the “surprise prize question” appears in Phase II and the primary players fail to provide a correct answer, the “surprise prize question” is passed on to the research players who will then compete for the “surprise prize” by attempting to be the first to provide a correct answer. If none of the research players provide a correct answer to the “surprise prize question” then the “surprise prize” is not awarded to any team. At the end of Phases I and II the team that has accumulated the most points and/or money gets to participate in Phase III.

Phase III of the game show is a bonus round and provides the teams a chance to win a bonus prize. Phase III is structured like a treasure hunt in which the contestants search for items on the Internet such as, for example, pictures of people or objects, URL's, quotes, addresses of famous places, and other information. The selected team pulls a handle 42 of the digital slot machine 44 which contains a number of different bonus prizes 46 such as, for example, vacation trips, high-end computer systems, televisions, stereo systems, and big cash prizes. Slot machine may be viewed on a large screen monitor 47. If the team is not satisfied with bonus prize the team has the opportunity to spend some of the money earned during Phases I and II to spin slot machine 44 again in an attempt to win a different prize.

Once the team establishes a prize, one of the team members such as, for example, Player 1, moves into an isolation booth (not shown). The other player such as, for example, Player 2, moves to a PC 48 connected to a monitor, keyboard and mouse 50. The PC 48 is connected to Internet 18 through a central server 52. An adjacent monitor 54 is connected to central server 52 and displays a series of search tasks. Monitor 54 also displays a time clock that reflects the amount of time remaining for Player 2 to find all of the search items or to complete listed tasks. If, after a specified amount of time, Player 2 has not completed all of the tasks Player 1 then takes over and attempts to complete the tasks that Player 2 did not complete. Player 2 can stand next to the host and watch Player 1.

To win the bonus prize the combined results of both Player 1 and Player 2 must equal a certain percentage such as, for example, sixty-five percent of the search tasks. If the team successfully completes one hundred percent of the search tasks the team will win a second bonus prize that equals a predetermined dollar amount.

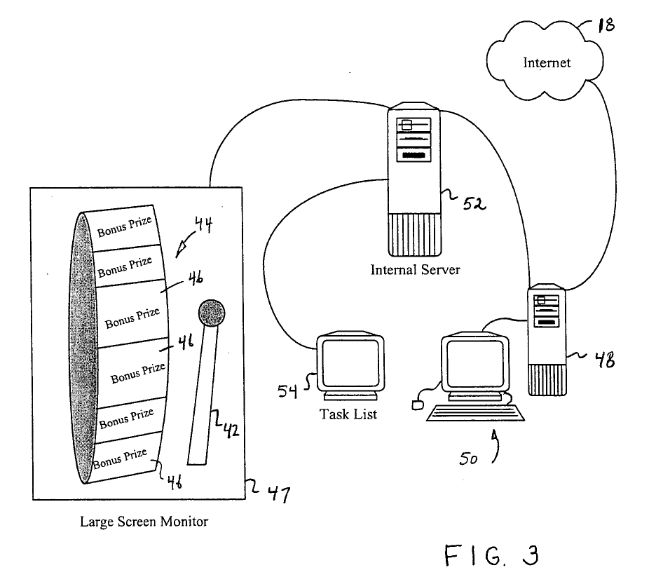

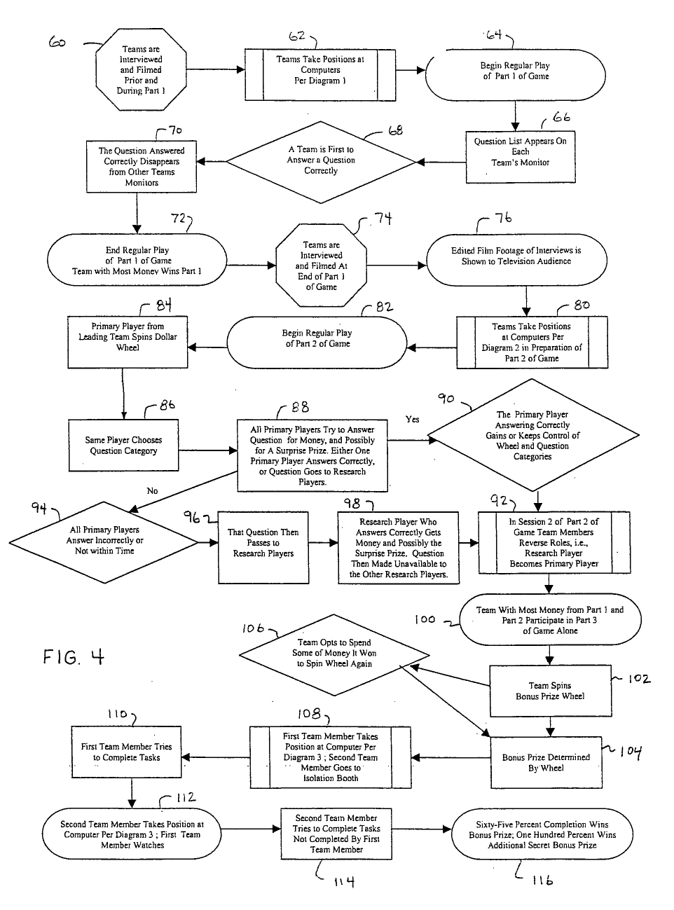

FIG. 4 sets forth the steps of the televised game show in which the team contestants are first interviewed and filmed during the interview prior to and during Phase I as seen in step 62. In step 64 the teams take their respective positions as set forth and described with reference to FIG. 1. Regular play of the game begins with step 64 as described above in which a question list appears on each team's monitor of step 66. The team that is first to correctly answer a question is represented by step 68. In step 70 the question that has been correctly answered disappears from the other team' monitors. The teams may also have a chance to win the “surprise prize.” Phase I is timed and after the allotted time has run the regular play of Phase I ends and the team with the most money wins as set out in step 72. In step 74, the teams are interviewed and filmed at the end of Phase I. In step 76, the filmed interview is edited and shown to a television audience. Phase II of the televised game begins with step 80 in which teams take their respective positions as set forth and described with reference to FIG. 2. Regular play of Phase II begins in step 82 as described above with reference to FIG. 2. In step 84 the primary player from the leading team spins wheel 32 (FIG. 2) for a dollar or value amount. The same player then chooses a question category in step 86 and in step 88 all primary players try to answer the question for money and possibly a “surprise prize.” The primary player who first provides the correct answer remains or gains control of wheel 32 and question categories in step 90. In step 92 the players of each team switch places so that the primary players become research players and vice versa. If none of the primary players provide a correct answer in the allotted time as set out in step 94 the question is passed to the research players in step 96. The team whose research player first provides the correct answer wins money and/or points and possibly the “surprise prize” and the question then becomes unavailable to the other research players as in step 98. Session two then begins as in step 92. At the end of Phase II the team with the most money and/or points has the opportunity to participate in Phase III without the other teams as in step 100. In step 102 the selected team spins slot machine 44 (FIG. 3) and a bonus prize is determined in step 104. If the team is not satisfied with the resulting prize they may opt to spend money for an opportunity to spin the wheel again as in step 106 to determine the bonus prize. The team members then take their associated positions in step 108 as described above with reference to FIG. 3 and the first team member tries to complete a designated task in step 110. If the first team member fails to complete the task within the allotted time the second team member is given access to the computer as the first team member watches in step 112. The second team member then attempts to complete the task in step 114. As in step 116, if the team totals sixty-five percent completion of the designated tasks within the allotted time the team wins the bonus prize. If the team totals one hundred percent completion of the designated tasks within the allotted time the team wins an additional secret bonus prize.

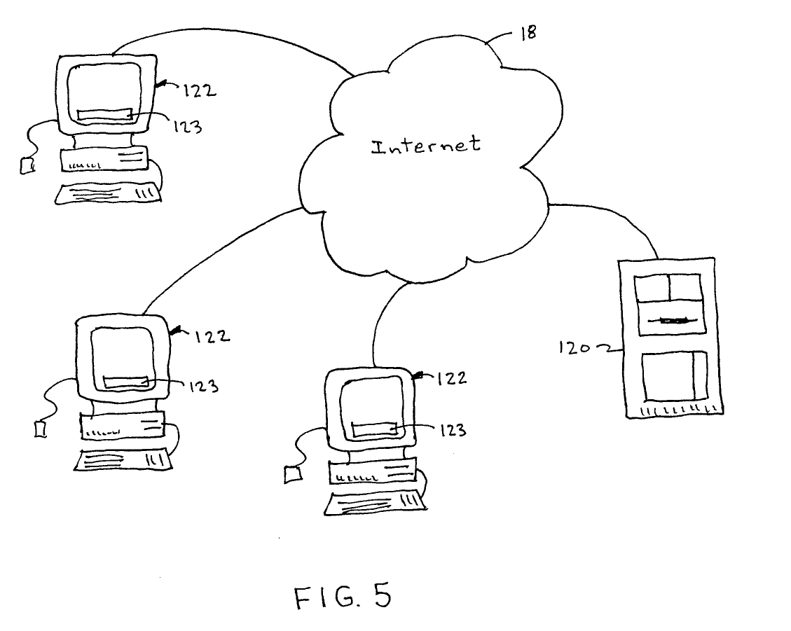

In another embodiment of the invention, at-home players can participate or compete in a game using the Internet 18 that substantially follows the same format as the televised game show. At-home players participate using a PC with Internet access as seen in FIG. 5. A game server 120 is connected to the Internet 18 telephonically or via any other connections. Game server 120 forms a Web site onto which at-home players can log onto to participate and compete using their own PC 122 connected to the Internet 18 either telephonically or via any other connection.

Individual players register with the game Web site using a valid e-mail address that is used to open their own account. As the at-home players complete each part of the game they can win points that are deposited into their accounts. These points can be redeemed for prizes or for chances to win big prizes in sweepstakes, including a chance to appear on the television game show. At-home contestants can play new games without limit in order to win more points. The chance to win points provides the incentive for constant game play on the Web site. The sweepstakes prizes are corporate sponsored. When players redeem the points for sweepstakes prizes, the corporate sponsors of the sweepstake's prize have direct knowledge of a contestant's desire for their product.

In addition to registering before playing the game, at-home players must download a “plug-in” application called a toolbar 123. Toolbar 123 acts as the control panel for the Web site game and remains a part of the player's browser even while the player is searching the Internet 18. Toolbar 123 provides either a place for the players to read questions, type in answers, view a game clock, or to provide a navigation utility to access or request Web pages to read questions, type in answers, or view a game clock.

After a player establishes an account and downloads toolbar 123, the player can log into the Web site to begin a game. After logging in, the player is assigned or paired with another player who has logged into the Web site. The two players form a team to compete against other teams consisting of two players similar to the television game show. The Web site game may be played by at least two teams (four at-home players) but not more than three teams (six at-home players). If at least one team is not logged into the Web site then players must wait until other players log into the Web site and form another team against which to compete.

Like the televised game show, the Web site game includes a Phase I timed research component and a Phase II rapid question-and-answer component. The team that accumulates the most points after Phases I and II can then play in a Phase III bonus round for additional points and prizes.

Phase I of the Web site game is a timed research project and has the same format as the televised game show. Each at-home contestant has a period of time to complete the research project. The amount of time allotted to each at-home contestant depends on the speed of their internet connection. Each team views the same question on the toolbar. Each research question will have a different point value determined by the difficulty value of the question. As soon as one team correctly types in the answer to a research question that question disappears from the toolbars of the other teams. The question is no longer available to the other teams regardless of how much time they have spent researching the question. Points are given for each right answer. Phase I ends when the time on the clock has expired or all of the questions have been answered correctly.

The team with the most points from Phase I is entitled to start the Phase II rapid question-and-answer session. Phase II of the Web site game follows the same format as the televised game show. Phase II includes two sessions. In each session, Player 1 and Player 2 from each team have different tasks. In the first session, one player is the primary player and the other player is the research player. In the second session, the team members reverse roles. The primary player is appointed randomly through the Web site software. Phase II also includes a digital slot machine or wheel that looks and works the same way as the slot machine wheel in the televised game show.

The primary player from the team with the most points from Phase I begins Phase II. This primary player starts by pressing a button on the toolbar that causes the digital slot machine wheel to spin. The wheel has various point values on it. Once the point value is established it remains for as long as the primary player remains in control by being the first to answer a question correctly.

Various subject categories are listed on the toolbar adjacent the digital wheel. The primary player in control chooses a question category. There are a fixed number of question in each question category. The difficulty of the question in the category becomes increasingly more difficult. Each primary player tries to answer the question by typing the answer in a designated place on the toolbar within a certain time. The first primary player to answer correctly gets the points for his or her team and remains in control of selecting the question category. The point value for the questions remains the same until a primary player loses control of selecting the questions. A primary player loses control if another primary player first answers correctly or if all players fail to answer the question correctly or fail to answer the question within the time limit.

If all primary players fail to answer the question within the specified time or fail to answer the question correctly then the question passes to all the research players who then see the passed question in their respective toolbars. When one of the research players correctly answers the question it is removed from the other player's toolbar or is removed from the Web page accessed by the toolbar. The research player who correctly answered the question wins the full point value of the question for his or her team. Control passes to or remains with the primary player associated with the research player who correctly answered the question. When control passes to another primary player he or she clicks the button of the digital wheel to determine a new point value and chooses the next question category until he or she loses control.

In addition to winning points, the primary players have a chance to win a special sweepstakes entry for their team. As in the televised game show, one of the questions in Phases I and II will be randomly designated as a special sweepstakes question. The designation is represented by an icon next to the written question as it appears on the toolbar or Web page accessed by the toolbar. The primary player that first correctly answers the question can win the special sweepstakes entry for his or her team. If the question is passed to the research players they will then compete for the special sweepstakes entry.

The team that gets the most points in Phases I and II can play a Phase III bonus round. The team plays alone and not against any other team on-line. The team in the bonus round can play for a sweepstakes entry for a bonus prize or they play for bonus points which are larger in value than points given in Phases I and II. In Phase III, one of the players from the team clicks on the button to spin the digital wheel. If the wheel lands on a prize then the players will play for a sweepstakes entry for the prize. If the wheel lands on points then the players will play for the additional points which will be added to their accounts. The team must play a shortened session in the bonus round. Each team member will read the questions on their respective toolbars and will try to answer the questions. If the team members get a number of the questions correct they will either win the sweepstakes entry or the points.

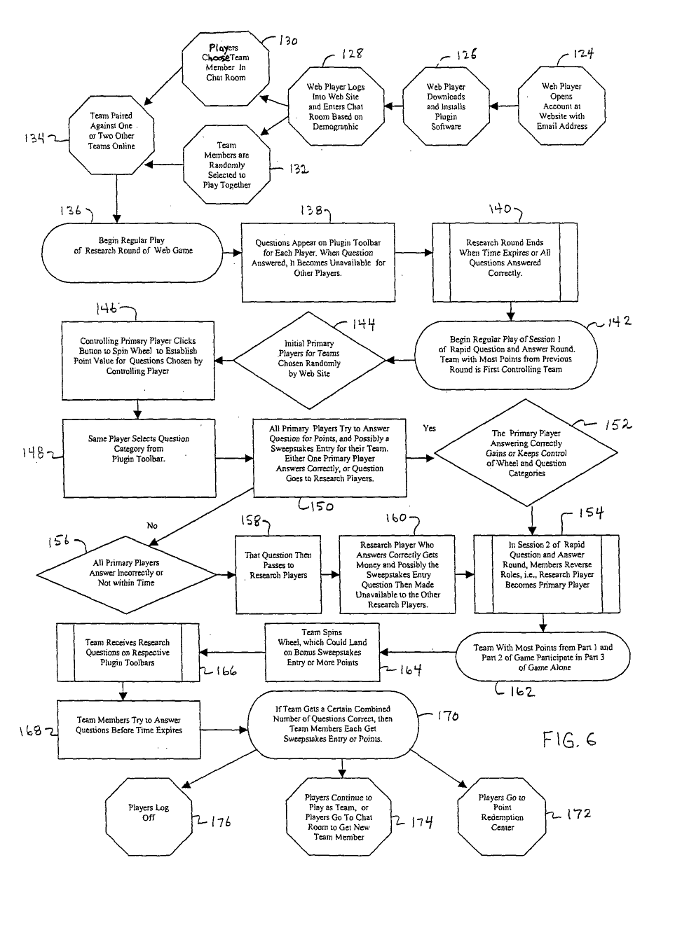

The steps for participating in the Web site game are set out in FIG. 6. In step 124 an at-home player opens an account at the Web site with a valid e-mail address. The player then downloads and installs the toolbar “plug-in” software in step 126. In step 128 the player logs into the Web site and enters a chat room based on demographics. The player either chooses a team member in the chat room in step 130 or players are randomly assigned a team member forming a team in step 132. In step 134 the formed team is paired with at least one other team and no more than two other teams. Regular play of Phase I of the game begins in step 136. In step 138, questions appear on the toolbar for each player. When the question is correctly answered it becomes unavailable for the other players. The research round ends in step 140 when time expires or all questions are answered correctly. Phase II begins with the first session in step 142 with the team with the most points from Phase I being the controlling team. The initial primary players for the teams are chosen randomly by the Web site in step 144. In step 146, the controlling primary players clicks a button on the toolbar to spin the digital wheel to establish the point value for questions chosen by the controlling player. In step 148, the same controlling player selects a question category from the toolbar. All primary players try to answer the question for points, and possibly a sweepstakes entry for their team in step 150. A primary player answers the question correctly or, if no primary players correctly answer the question, it passes to the research players. If a primary player correctly answers the question he or she gains or keeps control of the digital wheel and question category in step 152. The second session of Phase II begins in step 154 in which players from each team reverse roles of primary and research players. If, after step 150, no primary player correctly answers the question as in step 156 the question passes to the research players in step 160. The research player who correctly answers the question wins money and possibly the sweepstakes entry question. The question is then made unavailable to the other players and the second session of Phase II begins as discussed with step 154. In step 162, the team with the most points from Phases I and II participate alone in Phase III. The team spins the digital wheel in step 164. The digital wheel may land on a bonus sweepstakes entry or more points. In step 166, the team receives research questions on their respective toolbars. Team members try to answer questions before time expires in step 168. If the team correctly answers a certain combined number of questions correctly the team members each get sweepstakes entry points in step 170. Players can then either go to a point redemption center and have points credited to their account in step 172, continue to play as a team or go to the chat room to get a new team member in step 174, or log off in step 176.

We claim:

1. A method of playing a game on a television show, comprising the steps of:
providing a first phase of the game in which a plurality of teams compete in a timed project using computer equipment with Internet access to complete at least one designated task,
providing a second phase of the game in which the teams compete in a rapid question-and-answer session, and
providing a third phase of the game in which the team having the most points from the first and second phases participates in a bonus round for money and/or prizes.

2. The method of claim 1, further comprising the step of beginning the first phase of the game by interviewing and filming individual team members prior to, during, and after the first phase of the game to obtain filmed footage of the interviews.

3. The method of claim 2, further comprising the step of editing the filmed footage for broadcast to a television audience.

4. The method of claim 1, further comprising the step of providing each team with a personal computer (PC) linked to a game server, the PC having a question-and-answer monitor, keyboard, and mouse, and a research monitor, keyboard, and mouse.

5. The method of claim 4, further comprising the steps of displaying a question list on each team's question-and-answer monitor, and
providing each team with a designated amount of time to enter the answer in a designated place on the question-and-answer monitor by using their pre-existing knowledge or by researching the question over the Internet using the research monitor

6. The method of claim 1, comprising the step of beginning the second phase of the game by designating one team member from each team as a primary player and the other team member of each team as a research player.

7. The method of claim 6, comprising the step of separating the primary players from the research players so that the research players are located in an isolation booth.

8. The method of claim 7, comprising the steps of providing the primary players with an indicating device or computer equipment; and
selecting one of the primary players to select a dollar value and a question category; and
providing the primary players an opportunity to answer the selected question using the computer equipment so that the primary player that first correctly answers the question wins points.

9. The method of claim 8, comprising the step of passing the selected question to the research players if none of the primary players correctly answers the question.

10. The method of claim 9, comprising the steps of providing the research players with research computer equipment with Internet access, and
providing the research players with the opportunity to research the question using the Internet so that so that the research player that first correctly answers the question wins points

11. The method of claim 6, further comprising the steps of dividing the second phase of the game into two sessions in which a primary player and a research player participate in a first session, and
switching the primary player and research player of each team for a second session.

12. The method of claim 1, comprising the step of beginning a third phase of the game by determining and selecting the team having accumulated the most points from the first and second phases of the game.

13. The method of claim 12, comprising the step of providing the selected team with computer equipment having Internet access.

14. The method of claim 13, comprising the step of providing a task list which the team members must complete within a specified time using the computer equipment.

15. The method of claim 1, further comprising the step of providing a surprise question in either the first or second phase of the game providing the team members an opportunity to win a prize.

16. The method of claim 1, further comprising the step of providing a Web site through which at-home players can participate and compete in a Web site game to win money and/or prizes.

17. The method of claim 16, comprising the step of providing the Web site game with substantially the same format as the televised game show.
